(19) United States
(12) Patent Application Publication
(10) Pub. No.: US 2017/0045282 A1
(43) Pub. Date: Feb. 16, 2017

(54) Drain Flushing System

(71) Applicant: Douglas Thornberry, JR., Bartow, FL (US)

(72) Inventor: Douglas Thornberry, JR., Bartow, FL (US)

(21) Appl. No.: 14/826,673

(22) Filed: Aug. 14, 2015

(51) Int. Cl. F25D 17/02; F15D 1/00

(52) U.S. Cl. CPC F25D 17/02; F15D 1/0025

(57) ABSTRACT

A drain flushing system includes an HVAC unit. A drain is coupled to the HVAC unit such that the drain line may drain condensation from the HVAC unit. A flush line is fluidly coupled to the drain. The flush line is fluidly coupled to a fluid source thereby facilitating the flush line to selectively introduce a fluid into the drain such that the drain is cleaned. A control is coupled to the drain and the flush line. The control is operationally coupled to the drain and the flush line such that the control selectively actuates the flush line to introduce the fluid into the drain.

### BACKGROUND OF THE DISCLOSURE

Field of the Disclosure

The disclosure relates to flushing devices and more particularly pertains to a new flushing device for automatically cleaning a drain of an HVAC unit.

### SUMMARY OF THE DISCLOSURE

An embodiment of the disclosure meets the needs presented above by generally comprising an HVAC unit. A drain is coupled to the HVAC unit such that the drain line may drain condensation from the HVAC unit. A flush line is fluidly coupled to the drain.

The flush line is fluidly coupled to a fluid source thereby facilitating the flush line to selectively introduce a fluid into the drain such that the drain is cleaned. A control is coupled to the drain and the flush line. The control is operationally coupled to the drain and the flush line such that the control selectively actuates the flush line to introduce the fluid into the drain.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a drain flushing system according to an embodiment of the disclosure.

FIG. 2 is a front perspective view of an embodiment of the disclosure.

FIG. 3 is a schematic view of an embodiment of the disclosure utilizing manual valves.

FIG. 4 is a schematic view of an embodiment of the disclosure utilizing an electrical switch.

FIG. 5 is a schematic view of an embodiment of the disclosure utilizing an electrical timer.

FIG. 6 is a flow chart view of an embodiment of the disclosure.

### DESCRIPTION OF THE PREFERRED EMBODIMENT

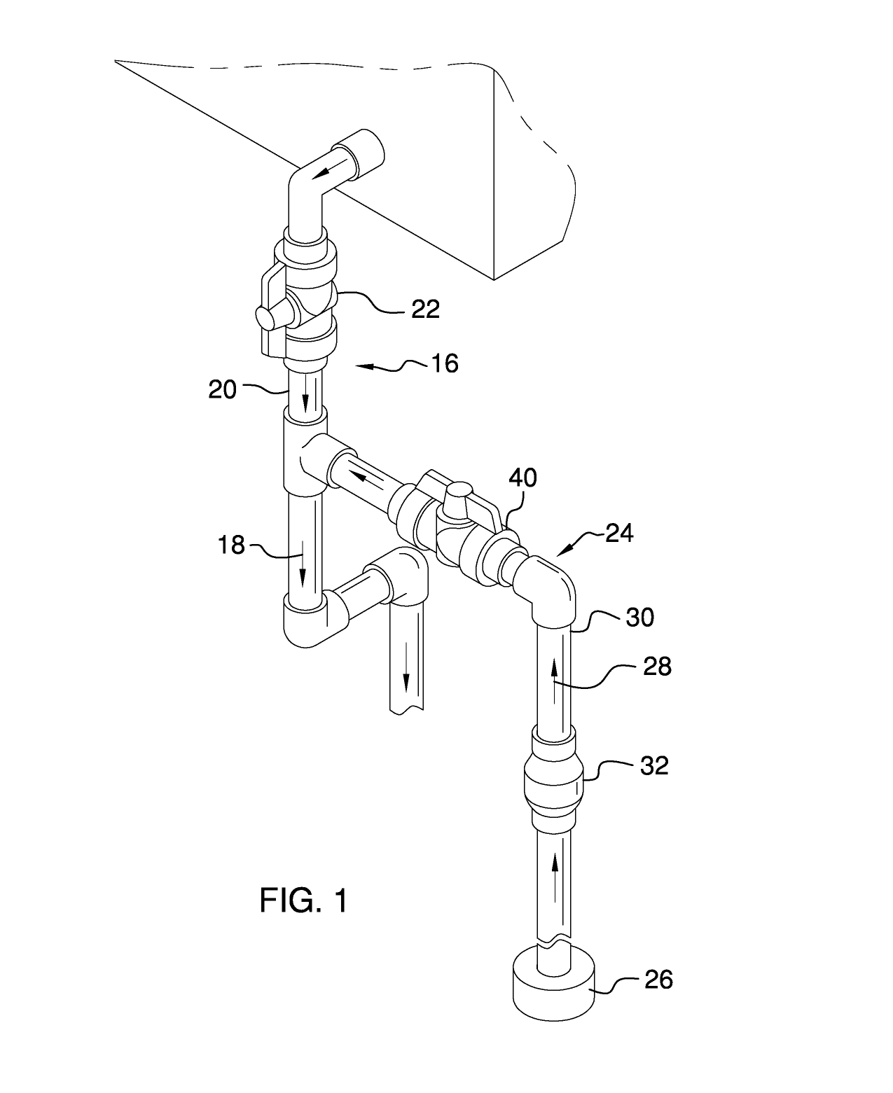

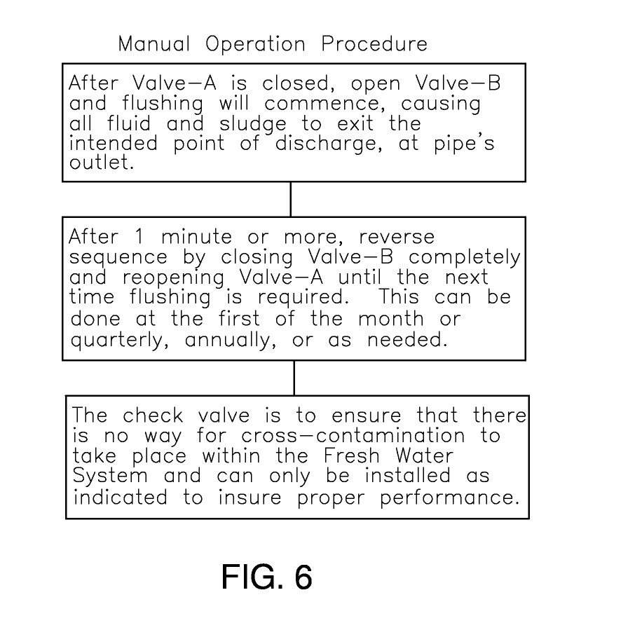

With reference now to the drawings, and in particular to FIGS. 1 through 6 thereof, a new flushing device embodying the principles and concepts of an embodiment of the disclosure and generally designated by the reference numeral 10 will be described.

As best illustrated in FIGS. 1 through 6, the drain flushing system 10 generally comprises an HVAC unit 12 that is positioned within a building 14. The HVAC unit 12 may be a forced air unit or the like that is utilized in the convention of heating or cooling the building 14. A drain 16 is coupled to the HVAC unit 12 such that the drain 16 drains condensation 18 from the HVAC unit 12.

The drain 16 comprises a first pipe 20 that is fluidly coupled to the HVAC unit 12. A first valve 22 is fluidly coupled to the first pipe 20. The first valve 22 selectively restricts and allows a flow of the condensation 18 through the first pipe 20. The first valve 22 may comprise an electrically actuated fluid valve 23 or the like.

A flush line 24 is fluidly coupled to the drain 16. The flush line 24 is fluidly coupled to a fluid source 26. Thus, the flush line 24 selectively introduces a fluid 28 into the drain 16 such that the drain 16 is cleaned. The fluid source 26 may be a water line and the fluid 28 may comprise water.

The flush line 24 comprises a second pipe 30 that is fluidly coupled to the first valve 22. The second pipe 30 is fluidly coupled to the fluid source 26. Thus, the first valve 22 selectively allows the fluid 28 to flow through the first pipe 20 such that the first pipe 20 is cleaned. A second valve 32 is fluidly coupled to the second pipe 30 such that the second valve 32 restricts a flow of the condensation into the fluid source 26. The second valve 32 may comprise a fluid check valve or the like.

A control 34 is provided and the control 34 is operationally coupled to the drain 16 and the flush line 24. Thus, the control 34 selectively actuates the flush line 24 to introduce the fluid 28 into the drain 16. The control 34 is electrically coupled to the first valve 22. The control 34 selectively actuates the first valve 22 into a first position. Thus, the first valve 22 allows the condensation 18 to flow through the first pipe 20 and the fluid 28 is restricted from flowing through the first pipe 20. The control 34 selectively actuates the first valve 22 into a second position. Thus, the first valve 22 restricts the flow of condensation 18 through the first pipe 20 and the fluid 28 is allowed to flow through the first pipe 20.

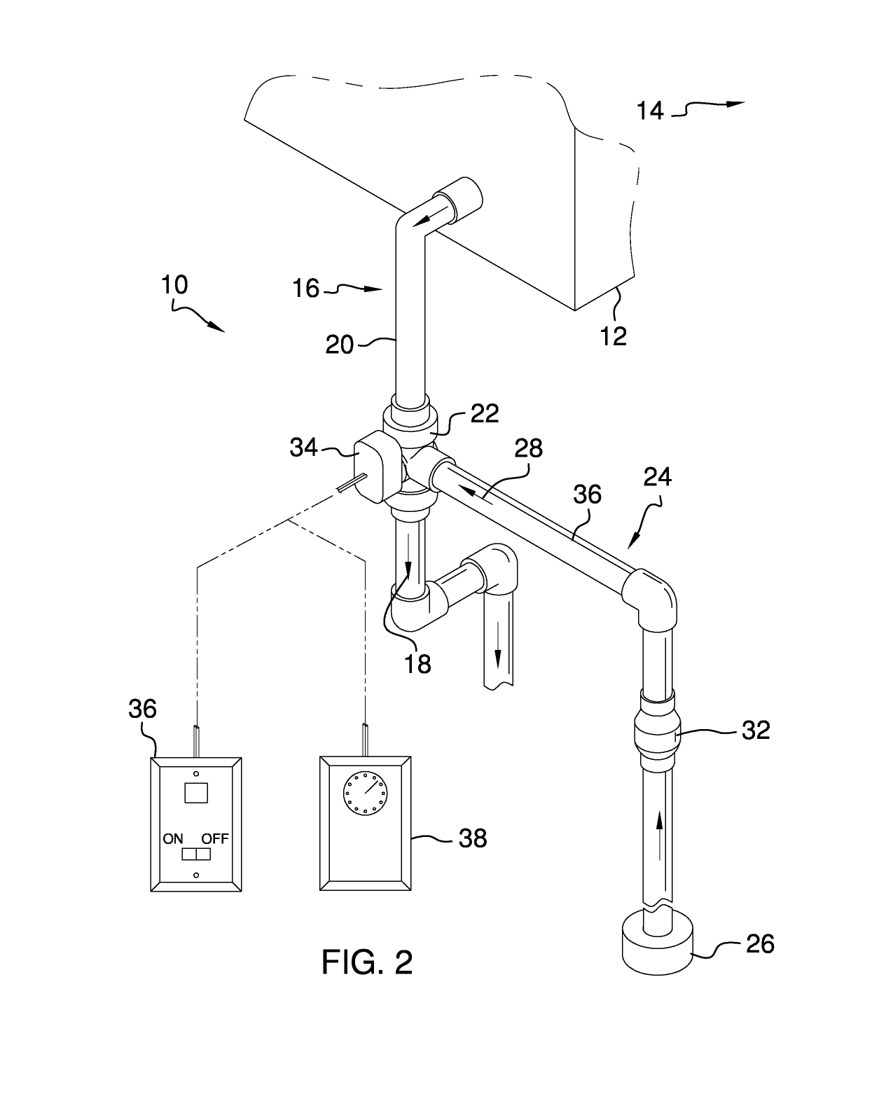

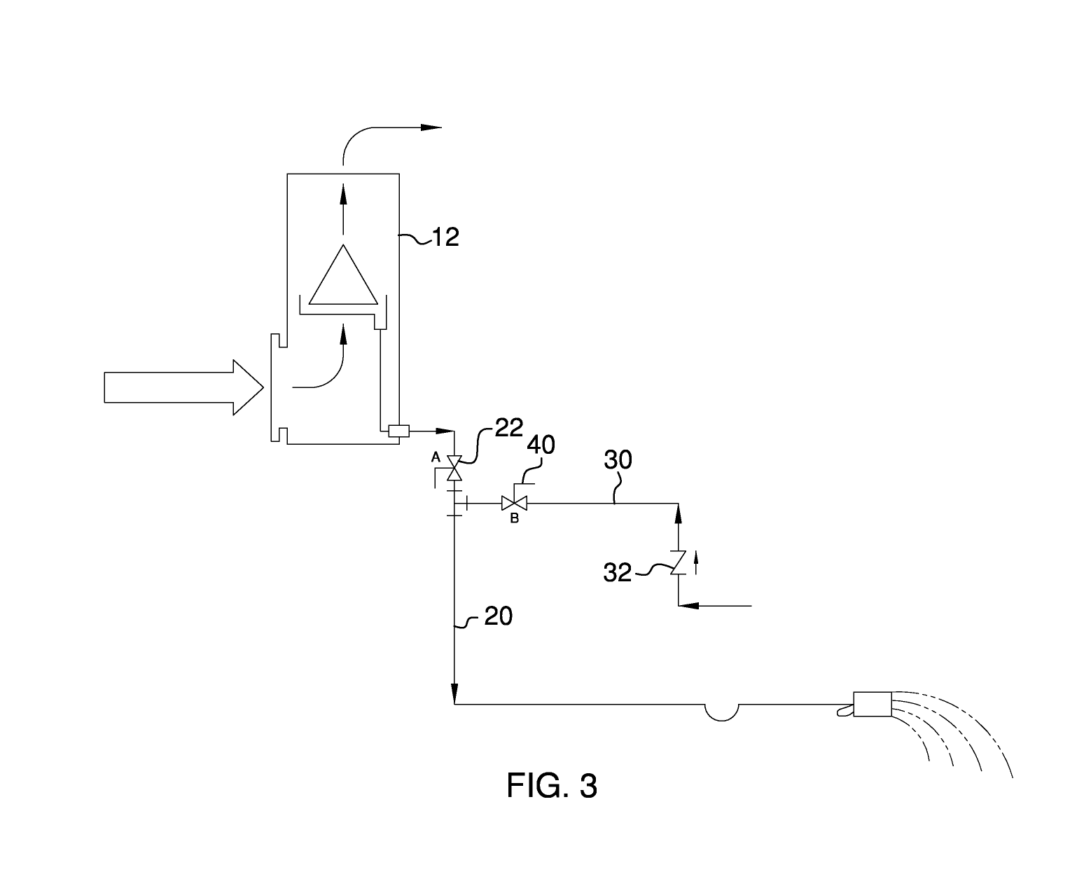

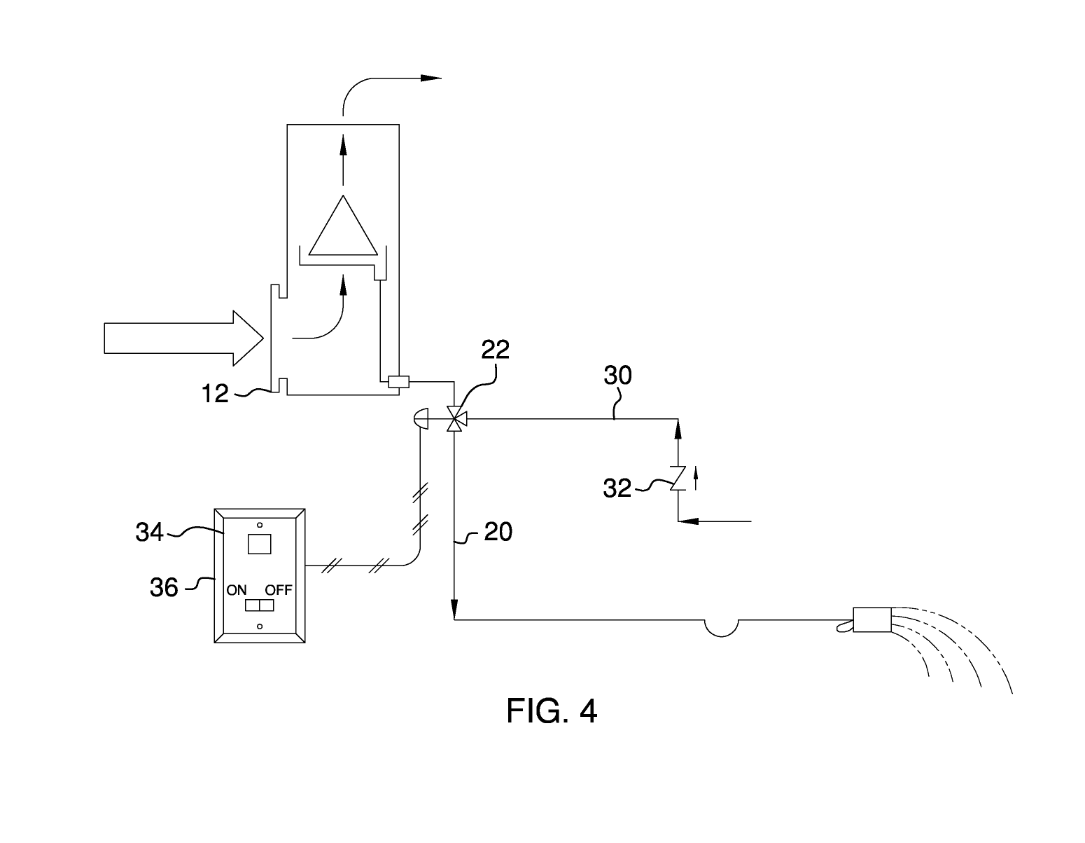

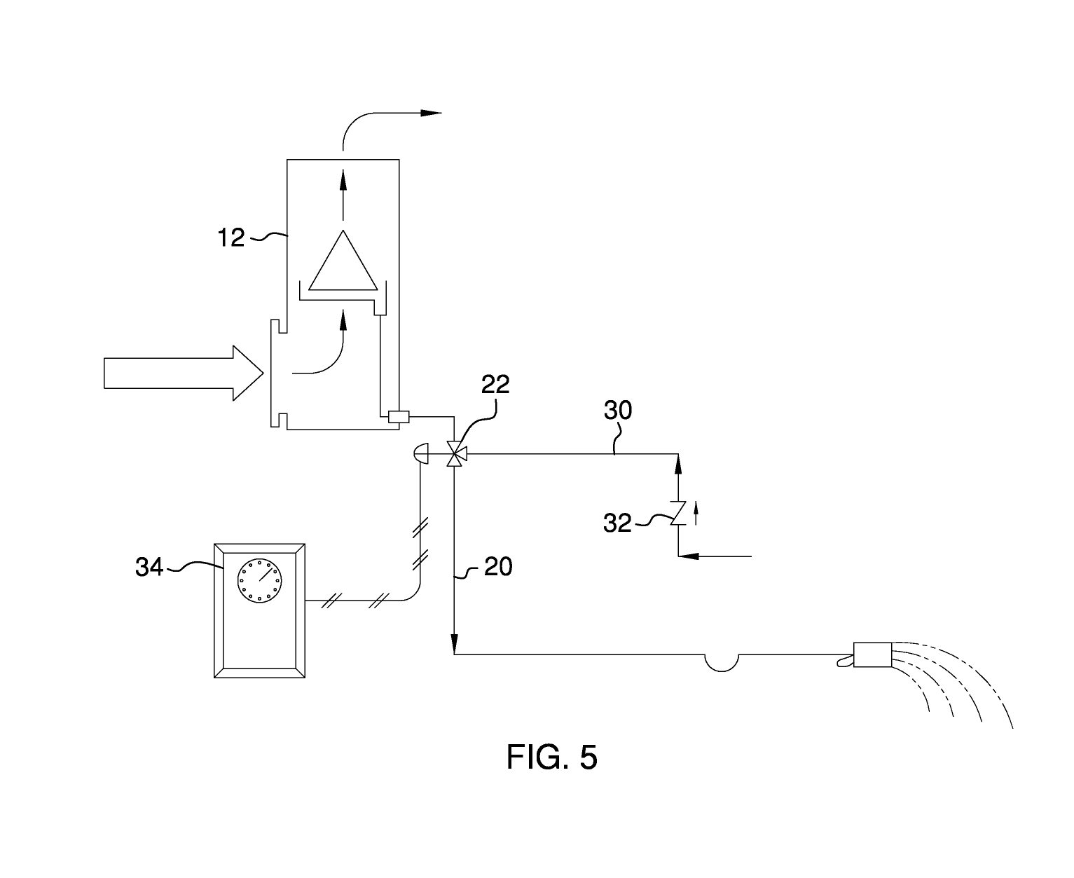

As shown in FIGS. 2 and 4, the control 34 may comprise an electrical switch 36 that may be manipulated to selectively actuate the first valve 22 into the first position and the second position. As shown in FIGS. 2 and 5, the control 34 may comprise an electrical timer 38 that automatically actuates the first valve 22 into the first position and the second position at a pre-determined time interval. As shown in FIGS. 1 and 3, the first valve 22 may comprise a manually operated fluid valve 25. As is further shown in FIGS. 1 and 3, a third valve 40 may be fluidly coupled to the second pipe 30. The third valve 40 is positioned between said second valve 32 and the first pipe 20. The third valve 40 may comprise a manually operated fluid valve 25.

In use, as shown in FIGS. 1 and 3, the first valve 22 is positioned in an open position and the third valve 40 is positioned in a closed position. Thus, the first pipe 20 allows the condensation 18 to flow outwardly from the HVAC unit 12 and the fluid 28 is prevented from flowing into the first pipe 20. The first valve 22 is positioned in a closed position and the third valve 40 is positioned in an open position. Thus, the first pipe 20 restricts the flow of condensation 18 from the HVAC unit 12 and the fluid 28 is introduced into the first pipe 20 thereby facilitating the first pipe 20 to be cleaned.

As shown in FIGS. 2 and 4, the electrical switch 36 is manipulated to position the first valve 22 in the first position. Thus, the first pipe 20 drains the condensation 18 from the HVAC unit 12 and the fluid 28 is restricted from flowing into the first pipe 20. The electrical switch 36 is manipulated to position the first valve 22 in the second position. Thus, the first valve 22 restricts the condensation 18 from flowing through the first pipe 20 and the first valve 22 restricts the fluid 28 from flowing into the HVAC unit 12. The first valve 22 allows the fluid 28 to flow through the first pipe 20 such that the first pipe 20 is cleaned.

As shown in FIGS. 2 and 5, the electrical timer 38 actuates the first valve 22 into the first position at a pre-determined time. Thus, the first pipe 20 drains the condensation 18 from the HVAC unit 12 and the fluid 28 is restricted from flowing into the first pipe 20. The electrical timer 38 actuates the first valve 22 into the second position at a pre-determined time. Thus, the first valve 22 restricts the condensation 18 from flowing through the first pipe 20 and the first valve 22 restricts the fluid 28 from flowing into the HVAC unit 12. The first valve 22 allows the fluid 28 to flow through the first pipe 20 such that the first pipe 20 is cleaned. The electrical timer 38 actuates the first valve 22 into the first position after a pre-determined duration of time.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A drain flushing system comprising:
an HVAC unit;
a drain being coupled to said HVAC unit wherein said drain line is configured to drain condensation from said HVAC unit;
a flush line being fluidly coupled to said drain, said flush line being configured to be fluidly coupled to a fluid source thereby facilitating said flush line to selectively introduce a fluid into said drain such that said drain is cleaned; and
a control being coupled to said drain and said flush line, said control being operationally coupled to said drain and said flush line wherein said control is configured to selectively actuate said flush line to introduce the fluid into said drain.

2. The system according to claim 1, wherein said drain comprises a first pipe being fluidly coupled to said HVAC unit.

3. The system according to claim 2, wherein said drain further comprises a first valve being fluidly coupled to said first pipe wherein said first valve is configured to selectively restrict and allow a flow of the condensation through said first pipe.

4. The system according to claim 1, wherein:
said drain includes a first pipe and a first valve; and
said flush line comprises a second pipe being fluidly coupled to said first valve, said second pipe being configured to be fluidly coupled to the fluid source thereby facilitating said first valve to selectively allow the fluid to flow through said first pipe such that said first pipe is cleaned.

5. The system according to claim 4, wherein said flush line further comprises a second valve being fluidly coupled to said second pipe wherein said second valve is configured restrict a flow of the condensation into the fluid source.

6. The system according to claim 4, wherein said control is electrically coupled to said first valve, said control selectively actuating said first valve into a first position wherein said first valve is configured to allow the condensation to flow through said drain line and the fluid is restricted from flowing through said drain line.

7. The system according to claim 6, wherein said control selectively actuates said first valve into a second position wherein said first valve is configured to restrict the flow of condensation through said drain line and the fluid is allowed to flow through said drain line.

8. A drain flushing system comprising:
an HVAC unit;
a drain being coupled to said HVAC unit wherein said drain line is configured to drain condensation from said HVAC unit, said drain comprising:
a first pipe being fluidly coupled to said HVAC unit, and
a first valve being fluidly coupled to said first pipe wherein said first valve is configured to selectively restrict and allow a flow of the condensation through said first pipe;
a flush line being fluidly coupled to said drain, said flush line being configured to be fluidly coupled to a fluid source thereby facilitating said flush line to selectively introduce a fluid into said drain such that said drain is cleaned, said flush line comprising:
a second pipe being fluidly coupled to said first valve, said second pipe being configured to be fluidly coupled to the fluid source thereby facilitating said first valve to selectively allow the fluid to flow through said first pipe such that said first pipe is cleaned, and
a second valve being fluidly coupled to said second pipe wherein said second valve is configured restrict a flow of the condensation into the fluid source; and
a control being coupled to said drain and said flush line, said control being operationally coupled to said drain and said flush line wherein said control is configured to selectively actuate said flush line to introduce the fluid into said drain, said control being electrically coupled to said first valve, said control selectively actuating said first valve into a first position wherein said first valve is configured to allow the condensation to flow through said drain line and the fluid is restricted from flowing through said drain line, said control selectively actuating said first valve into a second position wherein said first valve is configured to restrict the flow of condensation through said drain line and the fluid is allowed to flow through said drain line.
